(19) United States
(12) Patent Application Publication
(10) Pub. No.: US 2012/0189442 A1
(43) Pub. Date: Jul. 26, 2012

(54) Wind turbine with a braking device and method for braking at least one drive train component of a drive train, and use of a braking device for braking at least one drive train component of a drive train of a wind turbine

(76) Inventor: Matthias Wohlleb, Wurselen (DE)

(21) Appl. No.: 13/353,541

(22) Filed: Jan. 19, 2012

(30) Foreign Application Priority Data
Jan. 24, 2011 (EP) EP11151849

(51) Int. Cl. F03D 7/00; F03D 11/00; F03D 9/00

(52) U.S. Cl. 416/1; 416/169 R; 416/31; 416/39

(57) ABSTRACT

A braking device and method are provided for a wind turbine. The wind turbine includes a rotor, a generator and a drive train having one or more components. The drive train is connected to the generator for obtaining electrical energy from rotation of the drive train. The wind turbine further includes a braking device for braking at least one drive train component of the drive train. The braking device includes a wedge brake.

### CROSS REFERENCE TO RELATED APPLICATIONS

This application claims priority of European Patent Office application No. 11151849.4 EP filed Jan. 24, 2011. All of the applications are incorporated by reference herein in their entirety.

### FIELD OF INVENTION

The present invention relates to a wind turbine comprising a rotor and at least one drive train which is connected to a generator for obtaining electrical energy from rotation of the drive train, and having a braking device for braking at least one drive train component of the drive train. It also relates to a method for braking at least one drive train component of a drive train of a wind turbine having a rotor and at least the drive train which is connected to a generator for obtaining electrical energy from rotation of the drive train. It also relates to the use of a braking device for braking at least one drive train component of a drive train of a wind turbine comprising a rotor and at least the drive train which is connected to a generator for obtaining electrical energy from rotation of the drive train.

### BACKGROUND OF INVENTION

In a wind turbine, the wind's kinetic energy is used to cause a rotor to rotate. This rotational movement is transmitted via a drive train to a generator which generates electrical energy from the energy of rotation. Under normal operating conditions and when all the wind turbine's functional components are working properly, this process generally runs without external control action. However, in various hazardous situations, i.e. critical operating situations of the wind turbine it is necessary for the drive train to be braked. This is necessary particularly if individual components of the wind turbine are inoperative and further damage may be caused by rotation of the drive train. The same applies to maintenance situations in which the wind turbine is being serviced by technical personnel. These people usually work in the nacelle of the wind turbine and rotation of the drive train both hinders their work and exposes them to severe danger due to the enormous forces caused by said rotation. This means that, for maintenance purposes, the drive train generally has to be completely braked and locked in position in order to eliminate hazards and hindrances for the personnel involved.

Complete or partial braking of the rotation of the drive train is also necessary under extreme wind conditions, particularly storms and hurricanes. This is the only way of ensuring that no damage is caused to functional parts of the wind turbine, e.g. to the rotor or in the generator, during high wind speeds.

Accordingly, today's industrially used high-output wind turbines, i.e. producing more than 100 kW, are generally always equipped with braking devices which permit partial and also complete braking of the rotational movement of the drive train. Such braking devices usually consist of at least one brake caliper having at least one brake pad (each), said brake caliper incorporating a brake disk such that the brake pad can be pressed against the brake disk, thereby braking the moving brake disk. For this purpose the brake disk is fixed to a component of the drive train of the wind turbine. It therefore rotates with the same rotational speed as the drive train component; by slowing its rotational movement, the drive train component is reciprocally also slowed.

Such braking devices are usually controlled via hydraulic or pneumatic transmission systems. This means that the braking forces are transmitted and controlled using a hydraulic or pneumatic fluid in a closed loop. The necessary hydraulic pressure is mostly produced by a hydraulic pump or a compressor. The hydraulic or pneumatic forces are introduced by the opening of solenoid valves.

The particular requirements for braking devices in wind turbines are that the braking forces shall be reliably transmitted and a braking force that is as constant as possible shall also be applied. The forces at work during operation of a wind turbine attain enormous magnitudes, many times greater then in the powertrain of an automobile. Moreover, braking devices in wind turbines are subject throughout their lifetime not only to the rotational forces but also to other powerful mechanical stresses such as vibrations, resonance effects and damping effects. Especially in hazardous situations, all the forces acting on the drive train and therefore the generator are significantly increased yet again, so it is particularly necessary for the brakes to be able to apply constant braking forces over a comparatively long period and also operate reliably even at high temperatures. The reliability of transmission (by means of the pneumatic or hydraulic fluid) is nowadays mainly ensured by using additional filtering and cooling equipment. Filtering is used to ensure that the fluid can be used at all times such that the full braking force can be transmitted. Cooling is used to prevent overheating of the fluid and therefore overstressing of the hydraulic or pneumatic lines.

This means that both the pneumatic or hydraulic system of braking devices in wind turbines and the cooling or filtering equipment involve a high degree of technical and material complexity, resulting in exacting requirements in terms material, mounting space inside the cabin of the wind turbine, weight and cost. In spite of these efforts, because of the inertia of the hydraulic or pneumatic transmission means and the very difficult to control quality differences between the solenoid valves, adequate and precise control of the (above described) braking devices is very difficult to guarantee.

### SUMMARY OF INVENTION

Against this background, the object of the present invention is to provide a way of improving the braking of a drive train or rather of individual components thereof inside a wind turbine of the type mentioned in the introduction, preferably in particular such that it can be operated in a reliable and low-maintenance manner and costs can be saved in terms of materials and the work involved.

This object is achieved by the features of the independent claims.

Accordingly, in a wind turbine of the type mentioned in the introduction, the braking device comprises a wedge brake.

The drive train can be constituted by one or more drive train components, e.g. by a first shaft and a second shaft coupled to the first shaft via a transmission device (gearbox).

Using a wedge brake as part of the braking device has a number of important advantages over the prior art in which conventional braking devices of the kind described above are employed. A particular advantage is that less force is generally required for braking, or rather a greater braking effect of the braking device can be achieved using the same force. In addition, a wedge brake can be controlled more precisely and does not require a hydraulic or pneumatic supply system, thereby enabling the above described numerous technical problems associated with such systems to be eliminated. In particular, the filtering and cooling of the transmission fluids is obviously no longer required. Instead, the wedge brake merely requires an actuator which displaces the brake wedge so as to produce a desired braking effect, or such that the instantaneous braking effect is reduced.

Wedge brakes are currently being tried out in motor vehicles as new types of braking systems. For example, reference can be made in this context to the article Gombert, Bernd/Philip Gutenberg: “Die electronic Keilbremse” (The electronic wedge brake), Automobiltechnische Zeitschrift (ATZ) 11/08, 108^{th} year, November 2006, pp. 904-912. This article also provides a comparison between conventional hydraulic braking systems and an electronic wedge brake—in each case for braking systems in the automotive field. The article concludes that the electronic wedge brake requires less exertion of force and therefore less energy in order to achieve the same braking power as other automotive braking systems.

Over and above this advantage, wedge brakes used in the context of wind turbines are also particularly effective because the magnitudes of the forces at work and the heat potentially produced by friction are much greater than in automotive applications. Moreover, in contrast to motor vehicles, in a wind turbine braking must take place fully automatically and without human readjustment, whereas the actuator for operating the brake in a motor vehicle is ultimately human, i.e. the driver. This means that even more exacting requirements are placed on the absolute reliability of maintaining braking forces for braking the drive train of a wind turbine than is the case in the automotive field. However, experiments by the inventor have shown that the operation of wedge brakes in the wind turbine field is so reliable that there is all the more reason to use them there, the advantages being even greater in this large-scale application. First, the above described problems with braking devices according to the prior art are much more noticeable than in technical applications on the scale of internal combustion engines developing approximately 100 kW, as wind turbines of modern design invariably have power ratings in excess of 1 MW. Second, because of the size of the equipment, much more space is also available for the braking device, so ultimately wedge brakes of a simpler design can be used while still even contributing to a space-saving effect. For example, the brake disks in wind turbines are accordingly significantly larger and therefore provide more contact surface for the brake wedge of the wedge brake than is the case in the car engine compartment. Third, the transmission of force from the actuator to the actual brake plays a much more crucial role than in the automotive field. Lastly, due to its much finer controllability, the wedge brake even offers the possibility of providing an additional vibration damping effect, as will be explained in greater detail below. The invention does not therefore involve simply transferring a principle from one technical field of application to another, but involves successfully modifying a system used in medium-scale applications for use in a large-scale application in which there would intrinsically be expected to be numerous additional obstacles (such as the scale, the magnitude of the forces and the vibration effects) to overcome.

According to the invention, the method of the type mentioned in the introduction is further developed in that the braking is carried out by means of a braking device incorporating a wedge brake. Using the wedge brake it is possible, as mentioned above, to provide much better control over the braking process during braking, while at the same time achieving a high and constant braking effect more simply and with less expenditure of force and energy. This requires much lower operating costs than conventional braking devices of the type described above.

Accordingly the invention also involves using a braking device comprising a wedge brake for braking at least one drive train component of a drive train of a wind turbine comprising a rotor and at least one drive train which is connected to a generator for obtaining electrical energy from rotation of the drive train.

Further particularly advantageous embodiments and developments of the invention will also emerge from the dependent claims and the following description. The method according to the invention and the use according to the invention can also be further developed according to the respective dependent claims relating to the wind turbine and reciprocally.

With wedge brakes it is basically possible to adjust the control of the braking effect by means of mechanical transmission systems such as push-rod and/or toothed wheel gearboxes and/or control cables or in individual cases hydraulically or pneumatically, or even by human action. In order to increase the precision of the braking effect and be even better able to ensure a reliable and controlled sequence of operations, an electronic wedge brake with an electronic braking force controller is preferably used. Here electronic control commands are generated which are transmitted via transmission lines directly to an actuator and can be implemented by the latter by appropriate adjustment of the position of the wedge brake. There is therefore no need for indirect transmission by means of hydraulic transmission fluids with the corresponding fault proneness and high maintenance described above. Rather, electronic control and activation permits very finely tuned braking effects to be achieved, and this virtually in real time. Moreover, it is possible with a purely electronic control system to implement a closed loop system in which, for braking force control, a control unit is connected to (or rather incorporates) an evaluation unit which processes the brake measurement signals from a braking effect measurement so that the control unit can derive refined control commands for braking force control from the results of said signal processing. In other words, this provides for the first time a self-regulating system which, in spite of the wear inevitably occurring in braking devices, also allows precise braking force adjustment even during operation of the braking device.

In this context it is particularly preferred to use, for braking force control, a control unit which actively counteracts vibrations of at least one drive train component during operation. The control unit therefore runs a kind of “braking program” which, from vibration measurements of the respective drive train component, derives control commands which are suitable for braking the drive train component in the opposite direction to the vibration frequency. In this way the vibrations of the drive train component are picked up and effectively counteracted in a damping manner, thereby implementing for the first time an effective active countermeasure against powerful vibrations of the drive train components. This means that in the nacelle of the wind turbine there is much less risk of damage caused by such vibrations and various functional components of the wind turbine can be effectively protected against premature aging. This controlled countermeasure therefore ultimately means that the service life of the wind turbine as a whole can be significantly increased. Such vibration damping with the aid of the braking device is self-evidently impossible for wind turbines with conventional braking devices according to the prior art, as such braking devices (because of their inertia) do not have the same precision and time accuracy.

According to a preferred embodiment, the drive train comprises a first shaft and a second shaft as drive train components which are interconnected via a step-up gearbox which converts the slow rotational speed in the first shaft into the higher rotational speeds of the second shaft, so that on the one hand lighter generators can be driven and, on the other, drive train braking can be more finely tuned: a faster rotating shaft (compared to the rotational speed of the rotors and a first shaft directly connected thereto) can therefore be braked more precisely, because the braking effect in absolute values of the speed reduction can be more easily measured than in the case of slowly rotating shafts. Moreover, the second shaft has lower inertia than the slowly rotating shaft.

It is particularly preferred in the case of a wind turbine of this kind with a first shaft and a second shaft that the wedge brake is disposed in the region of the second shaft.

In addition, the wind turbine according to the invention preferably comprises a control unit for electronic braking force control, which control unit obtains signals from at least one sensor which, during operation, measures parameter values of the rotation of a drive train component and/or parameter values relating to temperatures in the interior of the wind turbine and/or weather conditions around the wind turbine.

Parameter values of the rotation of drive train components include in particular measured values for the rotation speed, torque or vibrations of the respective drive train component. Vibration measurement is used, for example, to counteract these vibrations (see above), while information concerning rotation speed or torque can be used in particular to initiate braking automatically if particular threshold values from which ultimately a hazardous situation may be inferred are exceeded. The same applies in respect of weather or temperature values, as the outside temperature or wind parameters or the like indicate whether partial or complete braking of the drive train is necessary to protect the wind turbine in storm conditions. The inside temperature is important in so far as it can indicate operating problems due to increased friction on components or similar malfunctions. The control unit is therefore a sensor-based controller and can process a plurality of possible input parameters that may be relevant in particular depending on the respective site, size and type of the wind turbine.

A particularly advantageous development of the wind turbine consists in that, if a threshold value relating to at least one parameter value obtained by one of the sensors is exceeded during operation, the control unit will initiate braking by means of the wedge brake, preferably complete braking of the drive train. The control unit therefore initiates emergency braking of the rotational movement of the drive train. Accordingly, the respective threshold value is selected such that, if said value is exceeded, it can be assumed that there is a high probability of risk to the operation of the wind turbine or more specifically to individual components thereof. Appropriate threshold values may relate both to the inside temperature and to the other above mentioned measured values or also include other threshold values based on different parameters depending on the design of the wind turbine.

The wedge brake preferably comprises the following components:
a brake disc connected to a drive train component to be braked,
a permanently installed support structure disposed on at least one flat side of the brake disk and having a guide surface,
a brake wedge mounted on the guide surface with, facing the guide surface, a surface corresponding in shape to that of the guide surface,
an actuator which, during operation, displaces the brake wedge along the guide surface.

The brake wedge can be both directly and indirectly in contact with the guide surface. For example, it can be connected to the guide surface via rollers or slide along it with the aid of a suitable sliding means.

The brake wedge preferably comprises a brake pad mounted on the side of the brake wedge opposite the guide surface in the direction of the brake disk, said brake pad being forced against the brake disk during brake application.

Such an arrangement of the components of a wedge brake is easy to assemble (possibly also to retrofit to existing braking devices) and uncomplicated in operation; in particular, the guiding of the brake wedge along the guide surface means that the braking effect of the wedge brake can be preset by means of the shape of the brake wedge and guide surface. For example, the shaping of the guide surface and/or of the brake wedge can be designed such that movement of the brake wedge does not produce a linear increase in force, but an exponential or conversely only a gradual increase in force.

A wedge brake having the components described above is advantageously operated by an electric motor as an actuator, preferably controlled by an electronic control unit. This makes it possible to use a system that is as electronic or as electrical as possible, in which only the above described components of the braking device are of mechanical design and control is provided completely electronically.

As regards the shaping of the guide surface, it is provided according to its first basic alternative that it is flat and aligned obliquely to an axis of rotation of the drive train component to be braked. Said guide surface preferably tapers steeply to the brake disk to be braked. A variant of this first alternative consists in that the guide surface is not flat, but describes a monotonically, preferably strictly monotonically rising or falling course in cross section, in the manner of link. This produces the effect, already mentioned above, of a nonlinear increase in braking force as the position of the brake wedge changes. The brake wedge preferably has a shape matching this guide surface shape.

A second basic alternative consists of a zigzag-shaped, e.g. W-shaped guide surface and/or brake wedge surface. Preferably both the guide surface and the brake wedge surface are of similar zigzag shape. Such a zigzag shape is illustrated, for example, in FIG. 1 of the article Roberts, Richard et al.: “Testing the Mechatronic Wedge Brake” SAE paper 2004-01-2766 and is described in the accompanying text. The teaching of this description is accordingly incorporated as a teaching in this patent application.

However, the zigzag shape need not necessarily be an angular zigzag, but can also be rounded. In other words, the guide surface and/or the brake wedge surface can have peaks and valleys, so that the brake wedge can be moved against the guide surface from an initial zero point in two different directions in order to achieve an increase in braking force. With this alternative, tighter contact between the guide surface and the brake wedge is possible; this enables a more compact system to be implemented, as it is consequently more stable because the brake wedge cannot, for example, escape completely from the guide surface in one direction.

In addition, it has been found advantageous for the wind turbine according to the invention to have a manually operated and/or motorized positioning device for turning the drive train component in the direction of a locking position provided. A positioning device of this kind enables the respective drive train component to be moved on from stationary (e.g. after complete braking) in order to place it in a secure locking position. The wedge brake need not necessarily be used for locking. Rather, other braking devices can fix the drive train component directly or indirectly so that, for example, the wedge brake itself can also undergo maintenance.

It is therefore quite generally preferred that the wind turbine has a locking device for securing the drive train component to be braked in a locking position, said locking device preferably acting on a brake disk and/or on parts of the positioning device just mentioned.

This brake disk for locking purposes can be, for example, a brake disk of the wedge brake. However, a brake disk of another braking device can also be used for this purpose. With the aid of the locking device it is possible, without actuation of braking devices, to guarantee complete cessation of the rotational movement of the drive train component so that the braking device itself can also undergo maintenance.

### BRIEF DESCRIPTION OF THE DRAWINGS

The invention will now be explained again in greater detail with reference to the accompanying drawings on the basis of exemplary embodiments. Identical components are provided with the same reference characters in the various figures, in which:

FIG. 1 shows a greatly simplified schematic diagram of a wedge brake in cross section,

FIG. 2 shows a side view of an embodiment of a wind turbine according to the invention with its cabin opened,

FIG. 3 shows a detailed view from FIG. 2 of parts of the drive train and of the braking device of the wind turbine.

### DETAILED DESCRIPTION OF INVENTION

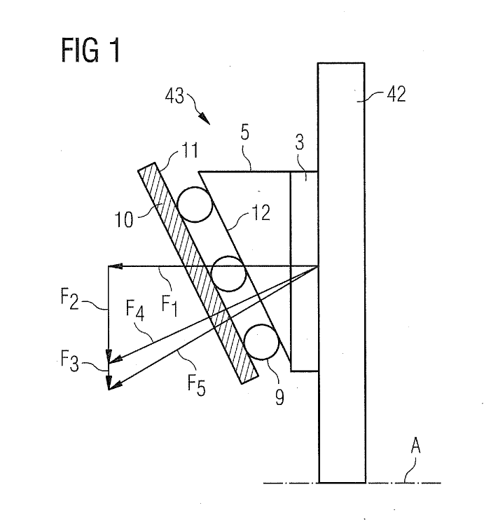

FIG. 1 shows a schematic side view of a wedge brake 43. It comprises a brake wedge 5 which moves on rollers 9 along a guide plane 11 of a support structure 10. A surface or bearing surface 12 of the brake wedge 5 faces in the direction of the guide plane 11 along which the rollers 9 are mounted. On the side of the brake wedge 5 opposite the bearing surface 12 is a brake pad 3 facing in the direction of a brake disk 42. The brake disk 42 rotates about an axis A to which the guide plane 11 is aligned obliquely, i.e. at an angle of neither 180° nor 90°. This means that the brake disk 42 rotates in the direction of the viewer's line of sight.

When the brake wedge 5 lies with the brake pad 3 pressed against the brake disk 42, a normal force F₁ and a frictional force F₂ tangential to the normal force F₁ are applied to the brake disk 42. In a triangle of forces, the combination of these two forces F₁, F₂ results in a combined braking force F₄. The braking of the brake disk 42 takes place in this state of equilibrium of forces. If the brake wedge 5 is pressed further in the direction of the axis A by an actuator force F₃, this produces a more powerful braking force F₅. Thus an increase in the braking force of the wedge brake 43 is to be achieved by displacing the brake wedge 5 in the direction of the axis of rotation A. Although the braking force of the wedge brake 43 does not increase quite as strongly as the actuator force F₃, after displacement of the brake wedge, no further additional force needs to be exerted in order to hold the brake wedge 5 in position. Instead, a new equilibrium of forces with a constant braking force F₅ is produced. The actuator force F₃ required is ultimately dependent on the friction characteristics of the contact between the brake disk 42 and the brake pad 3. The wedge brake 43 has reached its optimum braking point when no additional actuator force F₃ needs to be applied to displace the brake wedge 5 further in the direction of the axis A, thereby achieving the desired braking force in each case. A control unit which regulates the actuator force F₃ ultimately aims to attain precisely this point by bringing about an equilibrium of forces.

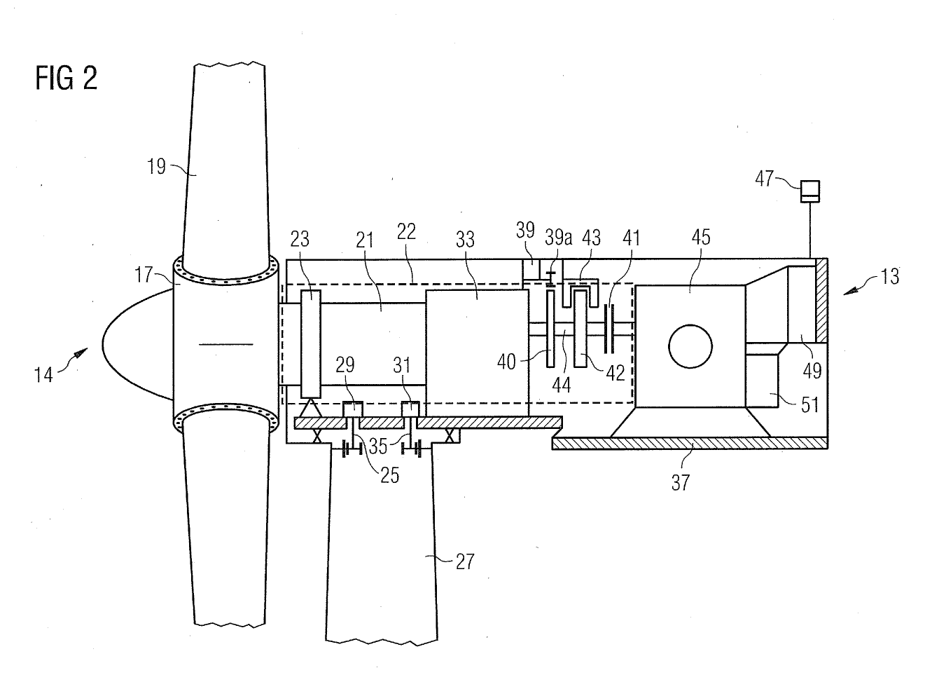

FIG. 2 shows a wind turbine 13 according to an embodiment of the invention. On its front windward side, it has a rotor 14 having a plurality of blades 19. These are connected to a hub 17. From the hub 17, a first shaft 21 extends inside the nacelle 37 of the wind turbine 13. The first shaft is mounted in the nacelle 37 via a main bearing 23 and a first cross member 25 and a second cross member 35 (the positions of which are adjustable via motors 29, 31).

A gearbox 33 converts the rotation of the first shaft 21 into a rotation of a second shaft 44, said second shaft 44 being disposed on the side of the gearbox 33 facing away from the first shaft 21. The second shaft 44 leads into a generator 45 in which electricity is obtained from the rotational energy of the second shaft 44. A coupling 41 is used to connect or disconnect the second shaft 44 in order to be able to decouple the generator 45 from the rotation of the second shaft 44 in hazardous situations. The first shaft 21 and the second shaft 44 together form part of a drive train 22. The generator 45 is cooled using a water cooler 49 and a supplemental fan 51. Instead of the water cooler 49, an oil cooler can also be used. Disposed on the exterior of the nacelle 37 is a meteorological sensor 47 which provides meteorological data such a wind conditions, temperatures, cloud and visibility.

Located in the region of the second shaft 44 is a positioning motor 39 which is interlocked with a toothed wheel 40 which is connected to the second shaft 44. Also connected to the second shaft 44 is a brake disk 42 which is braked by the braking device 43 according to the invention.

The nacelle 37 is rotatably mounted on a tower 27.

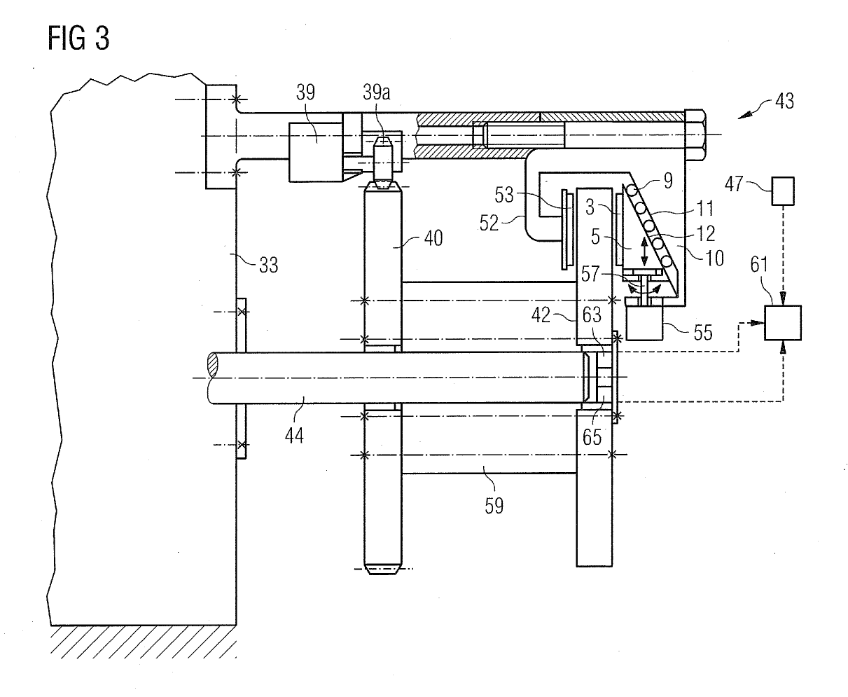

FIG. 3 shows in greater detail the region of the second shaft 44, in particular the braking device 43. From the gearbox 33, the second shaft 44 extends in the direction of the generator 45 (not shown here). The toothed wheel 40 is connected to the positioning motor 39 which engages in the toothed wheel 40 via a toothed wheel 39a. The positioning motor 39 is used to adjust the rotational position of the second shaft 44 such that a locking device 59 can engage in the toothed wheel 40 in a particular locking position, thereby fixing it. This means that the second shaft 44, and with it indirectly via the gearbox 33 the first shaft 21, is fixed and cannot rotate. Disposed further along in the direction of the generator 45 is a brake disk 42 and two sensors 63, 65 which on the one hand measure the rotation speed and torque respectively of the second shaft 44 and, on the other, its vibrations.

According to the invention, and as shown in detail here, the braking device 43 is implemented as a wedge brake for braking the rotational movement of the brake disk 42. This means that a brake wedge 5 according to the principle shown in FIG. 1 is moved up or down on rollers 9 over a guide surface 51 in order to achieve the required braking force F₃, F₅ on the brake disk 42. In addition to the brake pad 3 already shown in FIG. 1, a second brake pad 53 is disposed on the opposite side from the brake pad 3 via a brake caliper 52, so that the displacement of the brake wedge 5 of the wedge brake 43 produces a kind of clamping of the brake disk 42 between the (first) brake pad 3 and the second brake pad 53. An electric servomotor 55 adjusts via an adjusting wheel 57 the position of the brake wedge 5 of the wedge brake 43 such that the required braking force F₃, F₅ is achieved. The positioning motor 55 is controlled by a control unit 61 which uses input data from sensors, in particular the rotation sensor 63, the vibration sensor 65 and the meteorological sensor 47, to produce control commands, e.g. for active damping of vibrations of the second shaft 44.

The data from these sensors can also indicate whether hazardous situations have arisen, on account of which the rotation speed of the second shaft 44 or rather of the entire drive train 22 must be reduced or completely brought to zero, as the case may be. The control unit 61 can ultimately precisely set the optimum instantaneous braking force of the wedge brake 43 as a function of this and other input data (e.g. also measurement data concerning the current braking effect of the wedge brake 43).

In conclusion, attention is once again drawn to the fact that the method described in detail above and the wind turbine illustrated and its components are merely exemplary embodiments which can be modified in different ways by a person skilled in the art without departing from the scope of the invention. Furthermore, the use of the indefinite article “a” or “an” does not exclude the possibility that there may be more than one of the features in question. In addition, “units” may consist of one or more components which may also be disposed in a spatially distributed manner.

1. A wind turbine, comprising:
a rotor,
a generator,
at least one drive train connected to the generator for obtaining electrical energy from rotation of the drive train, the drive train having one or more drive train components, and
a braking device for braking at least one drive train component of the drive train, the braking device comprising a wedge brake.

2. The wind turbine as claimed in claim 1, wherein the wedge brake is an electronic wedge brake with electronic braking force control.

3. The wind turbine as claimed in claim 2, further comprising a control unit for braking force control which actively counteracts vibrations of the at least one drive train component during operation.

4. The wind turbine as claimed in claim 1, wherein the one or more drive train components include a first shaft and a second shaft interconnected via a step-up gearbox.

5. The wind turbine as claimed in claim 4, wherein the wedge brake is disposed in the region of the second shaft.

6. The wind turbine as claimed in claim 1, further comprising a control unit for electronic braking force control, wherein the control unit obtains signals from at least one sensor which measures parameter values during operation of the wind turbine.

7. The wind turbine as claimed in claim 6, wherein the parameter values measured by the sensor are parameter values relating to the rotation of the at least one drive train component.

8. The wind turbine as claimed in claim 6, wherein the parameter values measured by the sensor are parameter values relating to temperatures inside the wind turbine.

9. The wind turbine as claimed in claim 6, wherein the parameter values measured by the sensor are parameter values relating to weather conditions around the wind turbine.

10. The wind turbine as claimed in claim 6, wherein, if a threshold value relating to at least one parameter value obtained by the at least one sensor is exceeded during operation, the control unit initiates braking via the wedge brake.

11. The wind turbine as claimed in claim 1, wherein the wedge brake comprises:
a brake disk connected to the at least one drive train component to be braked,
a permanently installed support structure with a guide surface, the structure being installed on at least one flat side of the brake disk,
a brake wedge mounted on the guide surface and having a brake wedge surface facing the guide surface and having a shape corresponding to that of the guide surface, and
an actuator that displaces the brake wedge along the guide surface during operation.

12. The wind turbine as claimed in claim 11, wherein the actuator is an electric motor controlled by an electronic control unit.

13. The wind turbine as claimed in claim 11, wherein the guide surface is a flat guide surface oriented obliquely to the at least one drive train component to be braked.

14. The wind turbine as claimed in claim 11, wherein the guide surface is a zigzag-shaped guide surface.

15. The wind turbine as claimed in claim 11, wherein the brake wedge surface is a zigzag-shaped surface.

16. The wind turbine as claimed in claim 1, further comprising a positioning device that is operable to enable the at least one drive train component that is to be braked, to be turned in the direction of a locking position provided.

17. The wind turbine as claimed in claim 1, further comprising a locking device for securing the drive train component to be braked in a locking position.

18. The wind turbine as claimed in claim 11, further comprising a locking device for securing the drive train component to be braked in a locking position, said locking device acing on the brake disk.

19. The wind turbine as claimed in claim 16, further comprising a locking device for securing the drive train component to be braked in a locking position, said locking device acting on a part of the positioning device.

20. A method for braking at least one drive train component of a drive train of a wind turbine, the wind turbine having a rotor, a generator and the at least the drive train which is connected to the generator for obtaining electrical energy from rotation of the drive train, the method comprising:
using a braking device comprising a wedge brake for braking the at least one drive train component of the drive train.
